(19) United States
(12) Patent Application Publication
(10) Pub. No.: US 2003/0059562 A1
(43) Pub. Date: Mar. 27, 2003

(54) Sleeve with attachment flange

(76) Inventors: Gerald T. Lien, Exton, PA (US); John H. Rutter, Schnecksville, PA (US); Angela Sudermann, Collegeville, PA (US)

Correspondence Address: Synnestvedt & Lechner LLP, Suite 2600, 1101 Market Street, Philadelphia, PA, 19107-2950, US

(21) Appl. No.: 10/230,196

(22) Filed: Aug. 28, 2002

Related U.S. Application Data
(60) Provisional application No. 60/316,374, filed on Aug. 31, 2001.

(51) Int. Cl. B32B 1/08

(52) U.S. Cl. 428/36.9; 428/99

(57) ABSTRACT

A sleeve for protecting and supporting elongated items is disclosed. The sleeve has a tubular portion defining an interior space adapted to receive the elongated items and a flange or web portion providing an attachment region for accommodating fasteners for attaching the sleeve to a support structure. The sleeve is formed of filamentary members woven, braided or knitted together which allows the tubular and web or flange portions to be integrally formed. Thermoplastic monofilaments used for the filamentary members allow the sleeve to be resiliently biased into a closed configuration which is manually manipulable to provide access to the interior space. Various forms of fasteners are used to attach the sleeve to the support structure, with hook and loop systems being particularly advantageous.

### RELATED APPLICATION

This application is based on and claims the benefit of U.S. Provisional Application No. 60/316,374, filed Aug. 31, 2001.

### FIELD OF THE INVENTION

The invention concerns sleeving for encasing, protecting and supporting elongated items and especially to sleeving having a flange extending from the sleeve to provide an attachment structure for mounting the sleeve onto supporting structure.

### BACKGROUND OF THE INVENTION

Protective sleeving is used extensively in automotive, marine and aerospace applications to provide protection and support for elongated items such as wiring harnesses, fiber optic cables, fuel conduits and hydraulic lines. Such items are routed through various compartments or even externally of the automobile, ship or aircraft and are often subjected to harsh environments, for example, the excessive heat and vibration in an engine compartment. Furthermore, it is often convenient to bundle such items together and maintain them in a neat and orderly manner to facilitate servicing and damp vibration which would otherwise cause noise and fatigue failure of metal parts such as wiring and solder joints. Damping is especially useful in passenger compartments of automobiles where wiring harnesses are routed throughout the interior and behind and beneath the dashboard. The wiring should be securely bundled and attached to support points on the vehicle to prevent annoying rattle noise.

While ensheathing a item in a protective sleeve can protect the item against physical damage, abrasion, fatigue, radiative heat and provide noise damping qualities, it must also provide convenient access to the item, for example, to permit the item to be covered and exposed readily for repair, to form a splice or a break-out branch. Furthermore, the sleeve should securely and reliably support the item and retain it to the structure to which it is attached. This will ensure that, when subjected to inertial forces, the item remains positioned along its desired route and does not become entangled or ensnared with components or items which may move relatively to the item and, thus, cause undesired separation and failure of the item.

### SUMMARY OF THE INVENTION

The invention concerns a sleeve, attachable to a support structure, for protecting and supporting elongated items. The sleeve comprises a tubular portion formed of a plurality of interlaced filamentary members. The tubular portion defines an interior space adapted to receive the elongated items. An attachment flange is affixed to the tubular portion and extends outwardly therefrom. The flange, which is also preferably formed of interlaced filamentary members, comprises an engagement region adapted to engage fastening elements for attaching the sleeve to the support structure. Preferably, the tubular portion and the flange are integrally woven together with the flange extending substantially continuously lengthwise along the tubular portion.

Preferred fastening elements which engage the flange comprise hook and loop fasteners. Either the hooks or the loops may be integrally woven with the flange, the complementary portion of the fastener being attached to the support structure at the points to which it is desired to attach the sleeve. Other fasteners include button or “Christmas-tree” type fasteners comprising an elongated shaft having an enlarged head at one end and a retaining means positioned on the shaft. The shaft is insertable through the flange and into an opening in a support structure. The retaining means, for example, one or more barbs extending from the shaft engage the support structure to retain the fastener thereto. The enlarged head engages the engagement region of the flange for retaining the sleeve to the support structure. The flange may also be bonded to the support structure with adhesive or adhesive tape.

The tubular portion normally forms a closed tube which supports and retains the item held within its interior space. However, the tubular portion is also preferably openable along its length to provide ready access to the interior space. This feature permits elongated items to be placed within the interior space without having access to an end of the item and is thus ideal for effecting repairs, forming a splice or a break-out branch as necessary. Permanently enclosed tubular portions are also contemplated where there is no need for access to the interior space.

Preferably, the filamentary members forming the tubular portion are resiliently biased into a closed position, the filamentary members being resiliently flexible and, thus, allowing the tubular portion to be deformed between the closed and open configurations. This can be done for example, by resiliently biasing the tubular portion into a spiral, which may be manually unwound to provide access to the interior space, and which, being resiliently biased, winds itself back up around the item when released. Alternatively, the tube is formed of first and second sidewalls extending from the flange and arranged in spaced relation opposite one another thereby defining the interior space therebetween. The sidewalls each have an edge extending lengthwise along the tubular portion which together define a longitudinal seam in the tubular portion allowing access to the interior space. The sidewalls are resiliently biased so as to normally position the edges proximately with one another thereby closing the seam. The sidewalls, being resiliently deformable, allow the seam to separate anywhere along the edges to provide access to the interior space. In another alternate embodiment, fasteners, such as hooks and loops, zippers, buttons or lacing could also be positioned along the edges and used to close the seam.

The invention also contemplates sleeves having multiple tubular portions as well as multiple flanges extending from and between the tubular portions.

### BRIEF DESCRIPTION OF THE DRAWINGS

FIG. 1 is a perspective view of a sleeve according to the invention mounted on a support structure;

FIG. 2 is a perspective view of an alternate embodiment of the sleeve according to the invention;

FIG. 3 is a perspective view of another embodiment of the sleeve according to the invention;

FIG. 4 is a cross-sectional view taken along lines 4-4 of FIG. 1; and

FIGS. 5 and 6 are perspective views of alternate embodiments of the sleeve according to the invention.

### DETAILED DESCRIPTION OF THE PRESENTLY PREFERRED EMBODIMENTS

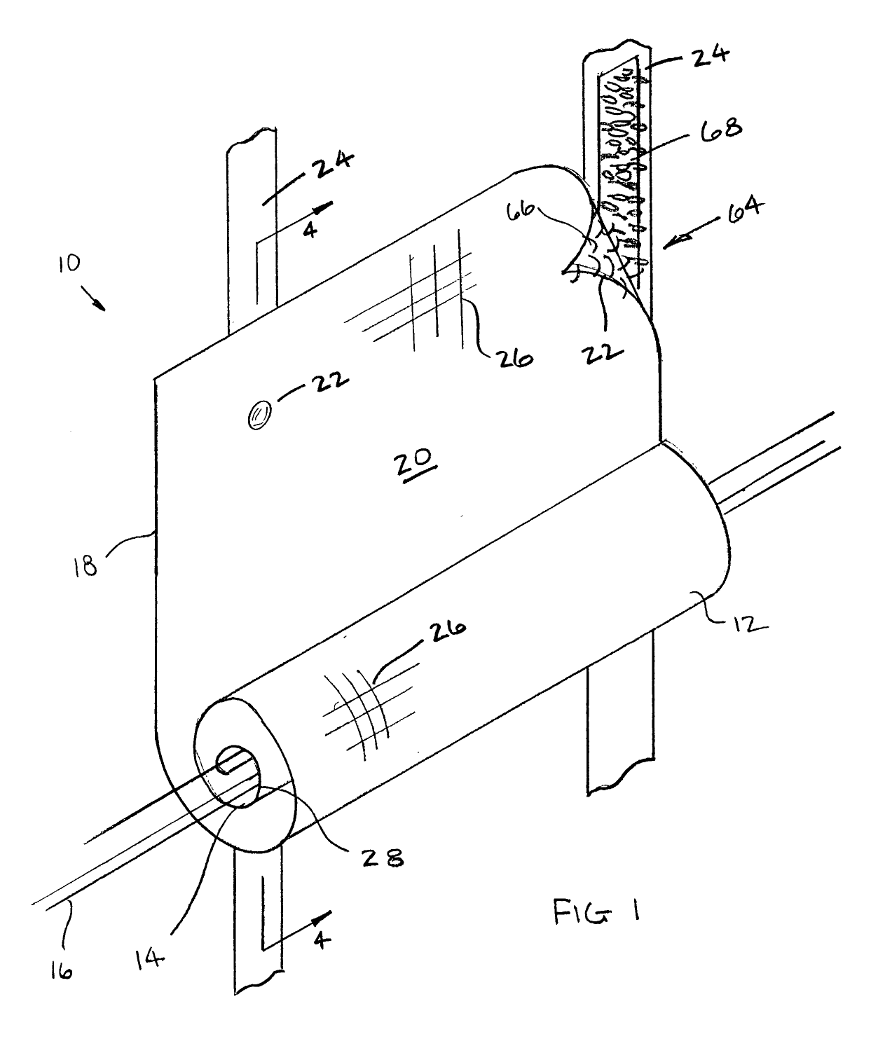

FIG. 1 shows a preferred embodiment of a sleeve 10 according to the invention, the sleeve comprising a tubular portion 12 defining an interior space 14 adapted to receive an elongated item 16. Sleeve 10 further comprises an attachment flange 18 affixed to the tubular portion and extending outwardly therefrom. Attachment flange 18 forms an engagement region 20 engaging fasteners 22 for attaching the sleeve 10 to a support structure 24. Preferably, both the tubular portion 12 and the flange 18 are integrally formed of interlaced filamentary members 26. The filamentary members are interlaced by weaving, although interlacing by knitting or braiding is also feasible.

Filamentary members 26 preferably comprise a thermoplastic material such as polyethylene based polymers (for example PET) which allows the tubular portion 12 to be biased into one of a number of closed positions (as described below) by deforming the tubular portion into the desired closed shape while applying heat. Other materials, such as polyester, nylon, polypropylene and PTFE may be used instead or combined with the PET.

Filamentary members 26 may be multi-filament yarns, monofilaments or combinations of the two. A practical example of a sleeve according to the invention is comprised of tufted (texturized) multi-filament warp yarns of 1250 denier PET, while the fill yarns are 9 mil monofilament PET. In another example, the flange has warp elements of monofilament PET with multi-filament fill yarns of 1250 denier tufted PET while the tubular portion has multi-filament tufted warp yarns. Multi-filament yarns provide for a relatively soft, flexible sleeve, allowing it to maintain a relatively low profile and conform readily to almost any curved path as required to route the item as required throughout a structure, such as an automobile chassis. Sleeves comprised of monofilaments have relatively greater abrasion resistance but less flexibility. Tufted or texturized yarns provide elasticity and damping characteristics to the sleeve. The multi-filament yarns and monofilaments may be combined with other materials such as a reflective foil layer to provide enhanced thermal protection against radiant heat, as well as non-woven materials such as polyester felt, to provide even greater noise damping characteristics.

Using resilient thermoplastic polymers for the filamentary members allows the tubular portion 12 to be conveniently biased by heat setting techniques into a shape which is normally closed around the interior space 14 but is manually deformable into an open configuration permitting access to the interior space at any point along the sleeve 10. Due to the resilient biasing provided by the filamentary members 26, the tubular portion 12 returns to the closed configuration by itself when the forces deforming it into the open configuration are released.

FIG. 1 provides an example of a tubular portion 12 biased into a closed, spiral shape 28 which wraps around the elongated item 16 to provide protection and support thereto. The spiral 28 is easily manually unwound to allow the item 16 to be inserted, spliced, repaired or divided to form a branch line. The biasing combined with the spiral shape allows the tubular portion 12 to be self closing and reliably retain the item within the interior space against inertial or contact forces which may try to displace it from its intended position. The tubular portion 12 is readily biased into the spiral shape 28 by curling it while applying sufficient heat to set the filamentary members 16 into the biased shape. This process can be performed continuously as the sleeve 10 is woven, the sleeve being fed from the loom directly to a device which heats and curls the tubular portion 12.

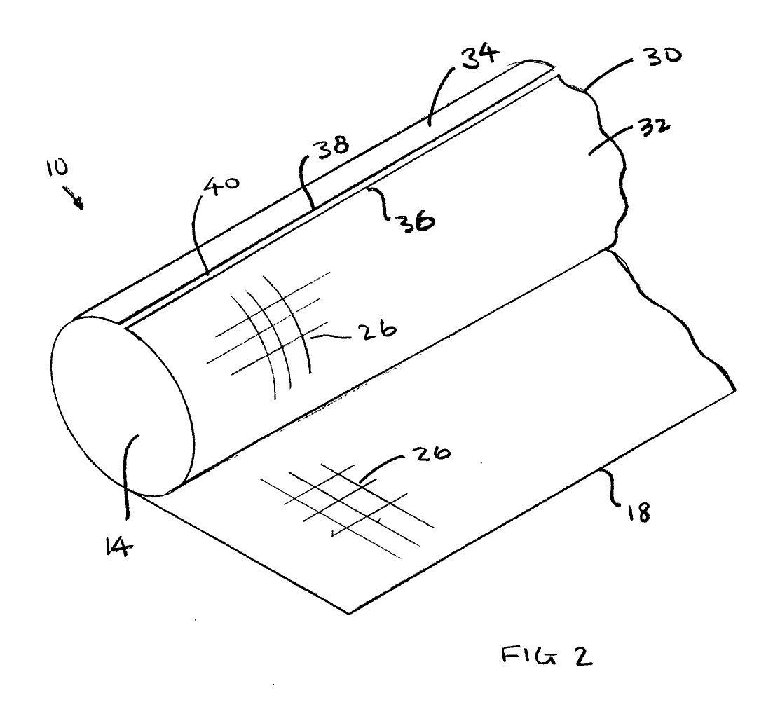

FIG. 2 shows an alternate embodiment of the sleeve 10 having a tubular portion 30 comprised of first and second sidewalls 32 and 34. The sidewalls extend from the flange 18 and are arranged in spaced relation opposite one another, thereby defining the interior space 14 between them. Each side wall has a respective edge 36 and 38 edge extending lengthwise along the tubular portion defining a longitudinal seam 40. The sidewalls are resiliently biased so as to normally position the edges 36 and 38 proximately with one another thereby closing the seam 40. When positioned proximately, the edges may be in overlying or overlapping relation or butted together. The sidewalls are resiliently deformable so as to allow the edges to be manually separated allowing access to the interior space. The resilient biasing of the filamentary members causes the sidewalls to close the seam 40 once forces deforming them into an open configuration are removed.

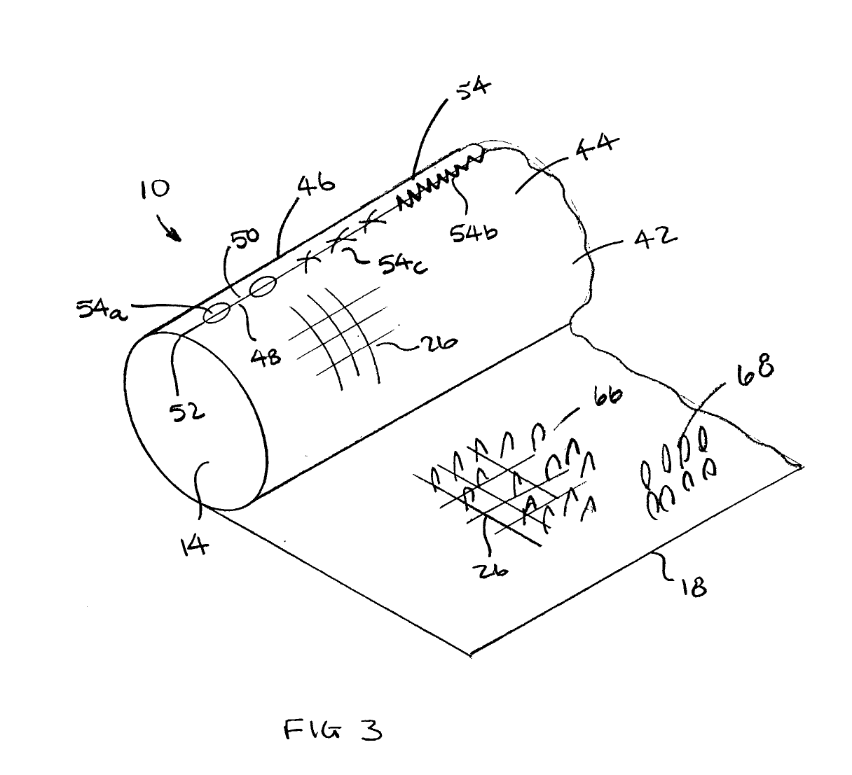

FIG. 3 shows another embodiment of a sleeve 10 according to the invention, the sleeve having a tubular portion 42 from which an attachment flange 18 extends. Tubular portion 42 is comprised of oppositely arranged sidewalls 44 and 46 which have respective edges 48 and 50. The sidewalls may be biased into a curved shape to bring the edges 48 and 50 together to define a lengthwise seam 52 along the tube, but in this embodiment, the biasing is not used to hold the tubular portion 42 in a closed position. Fasteners 54 are positioned along the edges 48 and 50 which engage one another to hold the tubular portion closed. Various types of fasteners are feasible, including buttons 54a, zippers 54b, lacing 54c or a hook and loop system (not shown). The embodiment of FIG. 3 may be used to support relatively heavy items or items subjected to significant inertial or contact forces wherein the biasing force of the filamentary members 26 is insufficient to retain the item within the interior space 14.

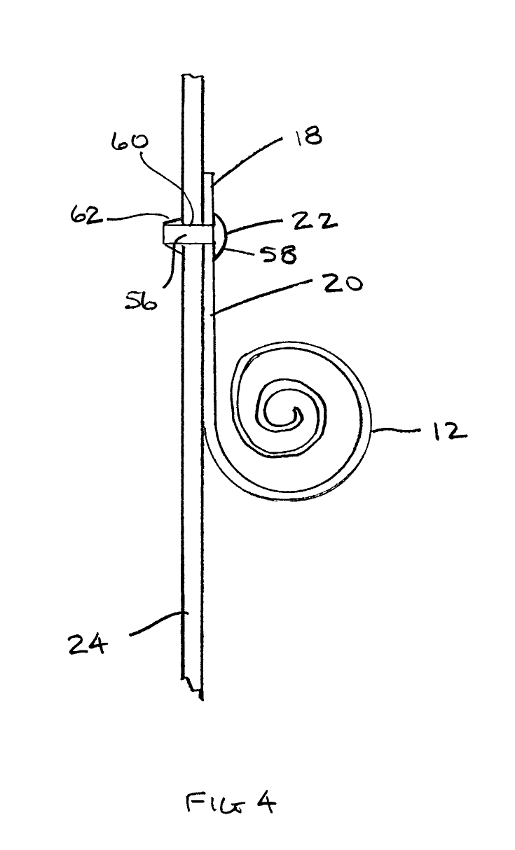

As shown in FIG. 1, flange 18 is used to attach the sleeve 10 to a support structure 24. The support structure could be, for example, part of an automobile chassis or body, an aircraft or ship structural member, or any other support. Flange 18 provides an engagement region 20 for engaging fasteners 22 to attach the sleeve 10 to the structure 24 as best illustrated in FIG. 4. Fastener 22 is a button or “Christmas-tree” type fastener comprising an elongated shaft 56 having an enlarged head 58 at one end and a retaining means positioned on the shaft. The shaft is insertable through the flange 18 and into an opening 60 in the support structure. The retaining means, for example, one or more barbs 62 extending from the shaft 56 engage the support structure to retain the fastener 22 thereto. The enlarged head 58 engages the engagement region 20 of the flange 18 for retaining the sleeve to the support structure.

Another fastener for attaching the flange 18 to the support structure 24 is shown in FIGS. 1 and 3 and comprises a hook-and-loop type fastening system 64. Either the hooks 66 or the loops 68 are attached to the flange 18, the complementary portion of this fastening system being attached to the structure 24. When the hooks and loops are engaged with each other, the sleeve 10 is securely retained to the structure. Among the advantages to using hooks and loops are that either the hooks or loops may be integrally woven into the flange 18 as shown in FIG. 3. Loops 68 are shown formed by overfeeding the filamentary members during weaving. This simplifies production and reduces the number of separate pieces which must be attached together to manufacture the sleeve. Furthermore, the hooks or loops positioned on the structure may be extended over a significant length of the structure (see FIG. 1) to allow for variable positioning of the sleeve. The hook and loop system also provides the advantage of being easily disengageable to allow the sleeve to be attached and removed multiple times, yet securely fix the sleeve to the structure once the two parts of the system are engaged.

Other attachment means are also feasible, such as adhesively bonding the flange to the structure or tethering the flange.

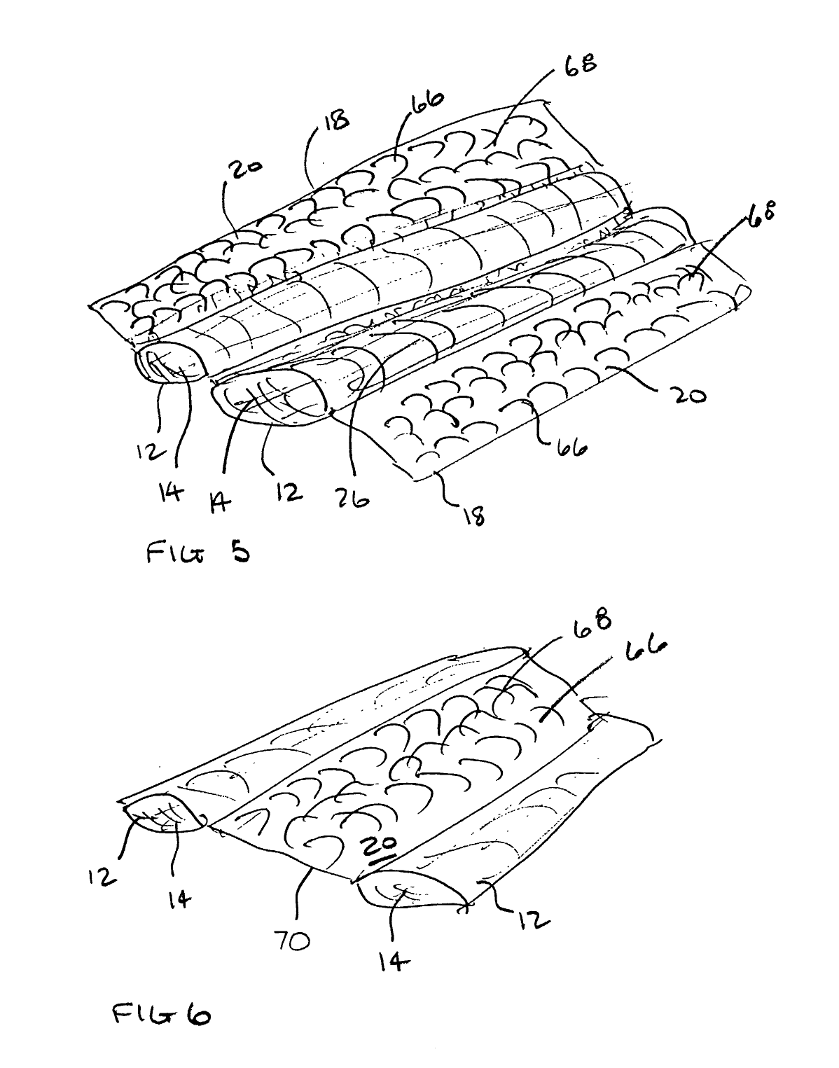

FIGS. 5 and 6 show alternate embodiments of the sleeve according to the invention comprising multiple tubular portions and flanges. The embodiment of FIG. 5 has two tubular portions 12 arranged side by side adjacent to each other, each tube having a respective flange 18 extending outwardly therefrom on opposite sides of the sleeve. Preferably, the tubes and the flanges are integrally formed together during weaving of the sleeve. The tubular portions shown are permanently closed in that they have no seam or other lengthwise opening providing access to their respective interior space 14, although such a configuration, as described above, is feasible for this embodiment. Preferably, hook or loop fasteners 66 and 68 are integrally woven with the flanges 18.

FIG. 6 shows a multiple tube sleeve embodiment in which the tubular portions 12 are separated by a web 70, which extends between them. Similar to flange 18, web 70 forms an engagement region 20 for receiving fasteners or fastening systems for attaching the sleeve to a structure. The tubular portions 12 are integrally woven with the web 70. Fastening systems of the hook and loop variety are advantageously used with this embodiment, as either or both the hook and loop fasteners 66, 68 may be integrally formed on the engagement region 20.

The sleeve with attachment flange according to the invention provides a versatile item for protecting and supporting elongated items. The sleeve provides protection from harsh environments including abrasion, radiant heat and fatigue due to vibration. Due to the presence of the attachment flange, the sleeve is easily mountable on any structure. Its woven construction provides for excellent flexibility and conformity, allowing the sleeve to accommodate any curvature or path and affords significant damping to suppress unwanted noise due to sympathetic vibration of the elongated item. Ready and convenient access is provided to the interior space of the sleeve by using biased filamentary members which force the sleeve into a normally closed configuration but allow it to be manually opened.

What is claimed is:

1. A sleeve for protecting and supporting elongated items, said sleeve being attachable to a support structure and comprising:
a tubular portion formed of a plurality of interlaced filamentary members, said tubular portion defining an interior space adapted to receive said elongated items; and
an attachment flange affixed to said tubular portion and extending outwardly therefrom, said flange comprising an engagement region adapted to engage fastening elements for attaching said sleeve to said support structure.

2. A sleeve according to claim 1, wherein said attachment flange is formed of a plurality of interlaced filamentary members.

3. A sleeve according to claim 2, wherein said filamentary members are interlaced by weaving, said attachment flange being integrally woven with said tubular portion.

4. A sleeve according to claim 2, wherein said attachment flange extends substantially continuously lengthwise along said tubular portion.

5. A sleeve according to claim 1, wherein said fastening elements include a fastener comprising an elongated shaft having an enlarged head at one end and a retaining means positioned on said shaft, said shaft being insertable through said flange and into an opening in said support structure, said retaining means engaging said support structure to retain said fastener thereto, said enlarged head engaging said engagement region of said flange for retaining said sleeve to said support structure.

6. A sleeve according to claim 1, wherein said tubular portion is resiliently deformable between a closed position wherein said tubular portion substantially surrounds said interior space, to an open position providing access to said interior space, said filamentary members being resiliently biased to normally maintain said tubular portion in said closed position.

7. A sleeve according to claim 1, wherein said tubular portion comprises:
an edge extending lengthwise there along, said edge being attachable to one of said tubular portion and said flange to form a seam lengthwise along said sleeve; and
a plurality of fasteners positioned along said edge for attaching said edge to said one of said tubular portion and said flange, said tubular portion being flexibly deformable between a closed position wherein said edge is attached and said tubular portion substantially surrounds said interior space, to an open position wherein said edge is unattached and provides access to said interior space.

8. A sleeve according to claim 7, wherein said fasteners comprise hooks and loops, one of said hooks and said loops being positioned along said edge.

9. A sleeve according to claim 8, wherein said hooks and said loops are positioned substantially continuously along said tubular portion.

10. A sleeve according to claim 1, further comprising a second tubular portion positioned lengthwise adjacent to said first named tubular portion.

11. A sleeve according to claim 10, wherein said flange extends between said first named and said second tubular portions.

12. A sleeve according to claim 10, further comprising a second flange extending outwardly from said second tubular portion, said second flange comprising a second engagement region adapted to engage fastening elements for attaching said sleeve to said support structure.

13. A sleeve according to claim 3, wherein said fastening elements include one of hook and loop fasteners integrally woven with said attachment flange.

14. A sleeve according to claim 1, wherein said tubular portion comprises first and second sidewalls extending from said flange and arranged in spaced relation opposite one another thereby defining said interior space therebetween, said sidewalls each having an edge extending lengthwise along said tubular portion and defining a longitudinal seam in said tubular portion allowing access to said interior space, said sidewalls being resiliently biased so as to normally position said edges proximately with one another thereby closing said seam, said sidewalls being resiliently deformable so as to separate said edges allowing access to said interior space.

15. A sleeve for protecting and supporting elongated items, said sleeve being attachable to a support structure and comprising a substrate formed from a plurality of interlaced, flexible, resilient filamentary members, a first portion of said substrate being resiliently biased into a spiral shape defining an interior space for receiving said elongated items, said first portion being resiliently deformable into a substantially flat configuration to provide access to said interior space, a second portion of said substrate being attached to said first portion and extending outwardly therefrom forming an engagement region for receiving fasteners for attaching said substrate to said support structure.

16. A sleeve according to claim 15, wherein said filamentary members comprise thermoplastic monofilaments.

17. A sleeve according to claim 15, wherein said fasteners comprise a hook and loop system, one of said hooks and loops being attached to said engagement region, the other being mounted on said support structure.

18. A sleeve for protecting and supporting elongated items, said sleeve being attachable to a support structure and comprising an elongated substrate formed from a plurality of interlaced, flexible filamentary members, said substrate having first and second tubular portions positioned in substantially parallel spaced relation to one another, said tubular portions each defining a respective interior space adapted for receiving said elongated items, a web of said substrate extending between and joining said tubular portions together, said web having a plurality of fasteners thereon for attaching said substrate to said support structure.

19. A sleeve according to claim 18, wherein said fasteners comprise one of a plurality of hooks and loops extending outwardly from said web for attaching said web to said structure, said structure having the other of said hooks and loops affixed thereon so as to be compatible with said fasteners on said web.

20. A sleeve according to claim 18, wherein said filamentary members comprise thermoplastic monofilaments woven together to form said substrate.
